(19) United States
(12) Patent Application Publication
(10) Pub. No.: US 2013/0328492 A1
(43) Pub. Date: Dec. 12, 2013

(54) ELECTRONIC DEVICE AND CONTROL CIRCUIT APPLIED THERETO

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: KUAN-HONG HSIEH, New Taipei (TW); DER-HO CHI, New Taipei (TW); JI-BAO FU, Shenzhen (CN); JIN-HUA ZHAO, Shenzhen (CN); XIAO-YUN CHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/901,578

(22) Filed: May 24, 2013

(30) Foreign Application Priority Data
Jun. 11, 2012 (CN) 2012202719754

(51) Int. Cl. G05F 1/46; H05B 33/08

(52) U.S. Cl. CPC G05F 1/46; H05B 33/0815
USPC 315/193; 323/282

(57) ABSTRACT

A control circuit for an electrical load in an electronic device includes a voltage divider, a current measurement circuit, a variable-current-output switch and a comparison circuit, the voltage entering the load and the voltage (and thus current) exiting from the load being monitored and compared to a reference voltage, any difference causing the switch to dynamically adjust the level of current being supplied, to protect the load from sudden variations in power supply and ensure a stable and constant supply of power.

### BACKGROUND

1. Technical Field

The present disclosure relates to an electronic device and a control circuit applied to the electronic device.

2. Description of Related Art

Electronic devices are usually driven by a constant current. However, external factors or internal factors may cause the voltage provided to the electronic devices or the current flowing through the electronic devices to increase abruptly, which will damage the electronic devices or may affect stability and service life of the electronic devices. Many types of control circuits are often employed in the electronic devices to adjust the current flowing through the load. However, these control circuits have a complicated structure and are expensive.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a control circuit which is employed in an electronic device, according to an embodiment.

FIG. 2 is an exemplary circuit diagram of the control circuit of FIG. 1.

### DETAILED DESCRIPTION

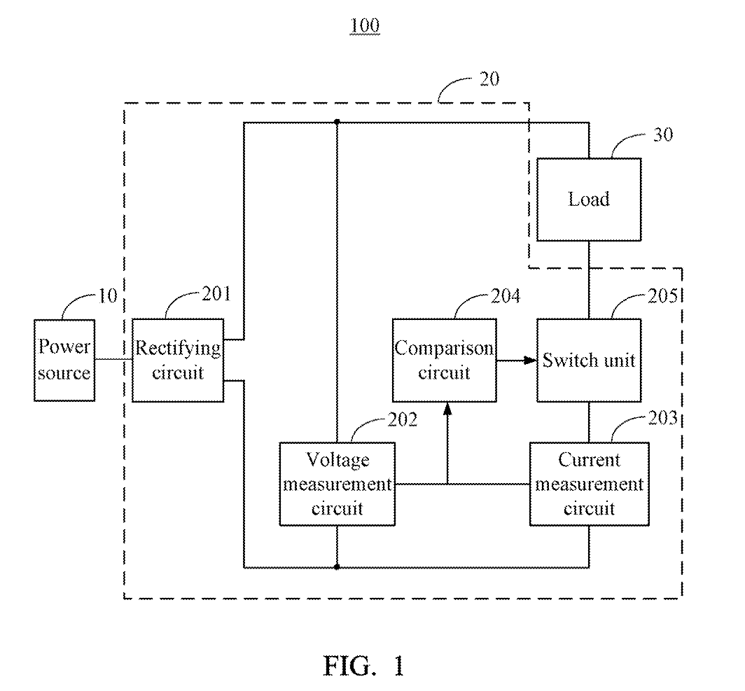

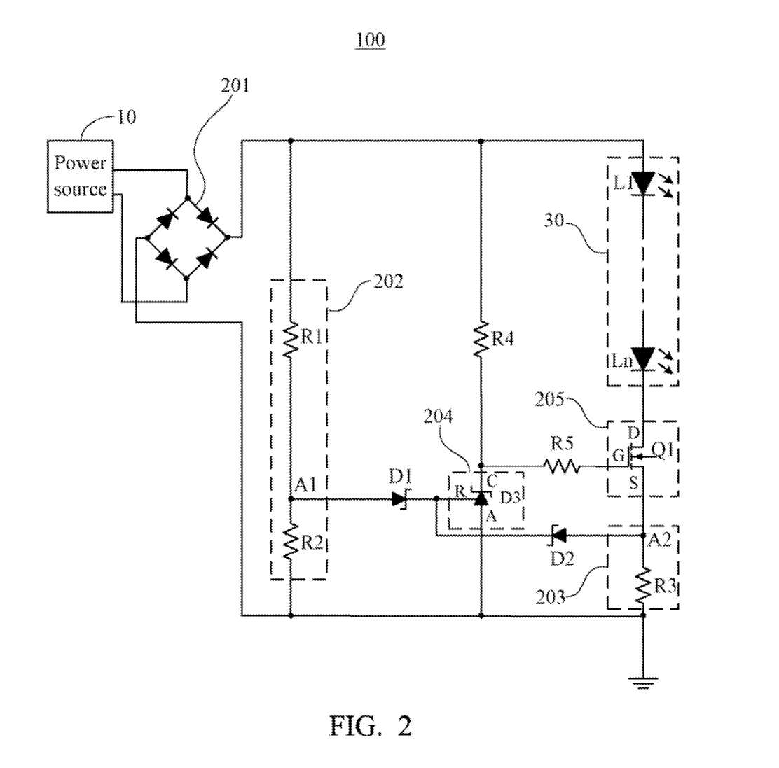

Referring to FIG. 1, an electronic device 100 includes a power source 10, a control circuit 20 and a load 30. In the embodiment, the load 30 is an LED light source including multiple LED units L1˜Ln connected in series (as shown in FIG. 2). The control circuit 20 monitors the voltage input to the load 30 and the current flowing through the load 30 as it flows through the load 30, and dynamically adjusts the value of the current flowing through the load 30 according to the monitoring, in order to provide a stable constant current for the load 30.

In the embodiment, the control circuit 20 includes an alternating current and direct current (AC/DC) rectifying circuit 201, a voltage measurement circuit 202, a current measurement circuit 203, a comparison circuit 204 and a switch unit 205. The AC/DC rectifying circuit 201 converts an alternating current power source 10 into direct current, and provides the direct current to the load 30.

The voltage measurement circuit 202 is coupled to an input of the load 30, and samples a voltage input to the load 30 so as to obtain a first sampling voltage. The current measurement circuit 203 is coupled to an output of the load 30, and samples a current flowing through the load 30 so as to obtain a second sampling voltage. The switch unit 205 is coupled to a current path of the load 30, and the comparison circuit 204 is coupled to the voltage measurement circuit 202, to the current measurement circuit 203 and to the switch unit 205.

Specifically, as shown in FIG. 2, the voltage measurement circuit 202 is a simple voltage divider circuit. In the embodiment, the voltage divider circuit includes a first resistor R1 and a second resistor R2 connected in series. A first node A1 is formed between the first resistor R1 and the second resistor R2. The first resistor R1 is connected between the output of the load 30 and the first node A1, the second resistor R2 is connected between the first node A1 and a ground terminal, and the first node A1 is coupled to an input R of the comparison circuit 204 via a first diode D1. In the embodiment, the first sampling voltage is taken from the first node A1 and then provided to the comparison circuit 204.

The switch unit 205 includes a control terminal G coupled to an output C of the comparison circuit 204 via a resistor R5, a first path terminal D coupled to the output of the load 30, and a second path terminal S coupled to the current measurement circuit 203. In the embodiment, the switch unit 205 is selected from a group consisting of a metal oxide semiconductor (MOS) transistor and a bipolar junction transistor (BJT).

The current measurement circuit 203 includes a third resistor R3. A second node A2 is formed between the third resistor R3 and the second path terminal S of the switch unit 205. In the embodiment, the third resistor R3 is coupled between the second node A2 and the ground terminal, and the second node A2 is coupled to the input R of the comparison circuit 204 via a second diode D2. The second sampling voltage is taken from the second node A2 and then provided to the comparison circuit 204.

The comparison circuit 204 includes a comparator D3. In the embodiment, the comparator D1 is a three-terminal voltage regulator, and includes the input R and the output C. In use, the first sampling voltage and the second sampling voltage are input to the input R of the comparator D3, and the comparator D3 compares the first sampling voltage and the second sampling voltage with a predetermined threshold voltage. In the embodiment, the predetermined threshold voltage is preset to be equal to an interior reference voltage of the comparator D3. The comparator D3 further outputs a control signal based on the result of comparison, to control the switch unit 205 to allow a certain level of current conduction, in order to adjust the value of the current flowing through the load 30, and provide a stable constant current for the load 30.

Specifically, if external factors cause the voltage provided to the load 30 to increase abruptly, the first sampling voltage is therefore increased; if internal factors cause the current flowing through the load 30 to increase or to decrease abruptly, the second sampling voltage is therefore increased or decreased accordingly. For each of these events, the comparator D3 compares the changed first sampling voltage or the changed second sampling voltage with the predetermined threshold voltage, and outputs a control signal based on the result of comparison, to control the switch unit 205 to switch to different levels of conduction. In the embodiment, the switch unit 205 is selectively switchable to one of different levels of conduction, by selectively applying one of different internal resistances. Thereby, the current flowing through the load 30 can be adjusted dynamically, and a stable constant current is provided to the load 30, insulating the load 30 from damage caused by high voltages or high currents.

Moreover, it is to be understood that the disclosure may be embodied in other forms without departing from the spirit thereof. Thus, the present examples and embodiments are to be considered in all respects as illustrative and not restrictive, and the disclosure is not to be limited to the details given herein.

What is claimed is:

1. A control circuit applied to an electronic device, the control circuit comprising:
a voltage measurement circuit for being coupled to an input of a load of the electronic device, and configured to sample a voltage input to the load thereby obtaining a first sampling voltage;
a current measurement circuit for being coupled to an output of the load, and configured to sample a current flowing through the load so as to obtain a second sampling voltage;
a switch unit for being coupled to a current path of the load; and
a comparison circuit coupled to the voltage measurement circuit, the current measurement circuit and the switch unit, wherein the comparison circuit is configured to receive the first sampling voltage and the second sampling voltage, and compare the first sampling voltage and the second sampling voltage with a predetermined threshold voltage, and then output a control signal based on the result of comparison, to control the switch unit to switch to different levels of conduction, in order to adjust the value of the current flowing through the load, and provide a stable constant current for the load dynamically.

2. The control circuit as described in claim 1, wherein the voltage measurement circuit is a simple voltage divider circuit.

3. The control circuit as described in claim 2, wherein the voltage divider circuit comprises a first resistor and a second resistor connected in series, and a first node is formed between the first resistor and the second resistor, wherein the first resistor is connected between the output of the load and the first node, the second resistor is connected between the first node and a ground terminal, the first node is coupled to an input of the comparison circuit via a first diode, and the first sampling voltage is taken from the first node and then provided to the comparison circuit.

4. The control circuit as described in claim 1, wherein the switch unit comprises a control terminal coupled to an output of the comparison circuit, a first path terminal coupled to the output of the load, and a second path terminal coupled to the current measurement circuit.

5. The control circuit as described in claim 4, wherein the switch unit is selectively switchable to one of different levels of conduction, by selectively applying one of different internal resistances.

6. The control circuit as described in claim 5, wherein the switch unit is selected from a group consisting of a metal oxide semiconductor transistor and a bipolar junction transistor.

7. The control circuit as described in claim 4, wherein the current measurement circuit comprises a third resistor, and a second node is formed between the third resistor and the second path terminal of the switch unit, wherein the third resistor is coupled between the second node and a ground terminal, the second node is coupled to an input of the comparison circuit via a second diode, and the second sampling voltage is taken from the second node and then provided to the comparison circuit.

8. The control circuit as described in claim 1, wherein the comparison circuit comprises a comparator, the comparator is configured to compare the first sampling voltage and the second sampling voltage with an interior reference voltage of the comparator, wherein the interior reference voltage of the comparator is preset to be equal to the predetermined threshold voltage.

9. The control circuit as described in claim 8, wherein the comparator is a three-terminal voltage regulator.

10. An electronic device comprising:
a load; and
a control circuit comprising:
a voltage measurement circuit for being coupled to an input of the load, and configured to sample a voltage input to the load so as to obtain a first sampling voltage;
a current measurement circuit for being coupled to an output of the load, and configured to sample a current flowing through the load so as to obtain a second sampling voltage;
a switch unit for being coupled to a current path of the load; and
a comparison circuit coupled to the voltage measurement circuit, the current measurement circuit and the switch unit, wherein the comparison circuit is configured to receive the first sampling voltage and the second sampling voltage, and compare the first sampling voltage and the second sampling voltage with a predetermined threshold voltage, and then output a control signal based on the result of comparison, to control the switch unit to switch to different levels of conduction, in order to adjust the value of the current flowing through the load, and provide a stable constant current for the load dynamically.

11. The electronic device as described in claim 10, wherein the load is an LED light source comprising multiple LED units connected in series.

12. The electronic device as described in claim 10, wherein the voltage measurement circuit is a simple voltage divider circuit.

13. The electronic device as described in claim 12, wherein the voltage divider circuit comprises a first resistor and a second resistor connected in series, and a first node is formed between the first resistor and the second resistor, wherein the first resistor is connected between the output of the load and the first node, the second resistor is connected between the first node and a ground terminal, the first node is coupled to an input of the comparison circuit via a first diode, and the first sampling voltage is taken from the first node and then provided to the comparison circuit.

14. The electronic device as described in claim 10, wherein the switch unit comprises a control terminal coupled to an output of the comparison circuit, a first path terminal coupled to the output of the load, and a second path terminal coupled to the current measurement circuit.

15. The electronic device as described in claim 14, wherein the switch unit is selectively switchable to one of different levels of conduction, by selectively applying one of different internal resistances.

16. The electronic device as described in claim 15, wherein the switch unit is selected from a group consisting of a metal oxide semiconductor transistor and a bipolar junction transistor.

17. The electronic device as described in claim 13, wherein the current measurement circuit comprises a third resistor, and a second node is formed between the third resistor and the second path terminal of the switch unit, wherein the third resistor is coupled between the second node and a ground terminal, the second node is coupled to an input of the comparison circuit via a second diode, and the second sampling voltage is taken from the second node and then provided to the comparison circuit.

18. The electronic device as described in claim 10, wherein the comparison circuit comprises a comparator, the comparator is configured to compare the first sampling voltage and the second sampling voltage with an interior reference voltage of the comparator, wherein the interior reference voltage of the comparator is preset to be equal to the predetermined threshold voltage.

19. The electronic device as described in claim 18, wherein the comparator is a three-terminal voltage regulator.
